(19) United States
(12) Patent Application Publication
(10) Pub. No.: US 2025/0315671 A1
(43) Pub. Date: Oct. 9, 2025

(54) SYSTEM FOR CORRECTING QUANTIZED DIFFUSION MODELS AND CORRECTION METHOD THEREOF

(71) Applicant: MEDIATEK INC., Hsinchu City (TW)

(72) Inventors: Yi-Chung CHEN, Hsinchu City (TW); Zhi-Kai HUANG, Hsinchu City (TW); Jing-Ren CHEN, Hsinchu City (TW)

(21) Appl. No.: 19/095,773

(22) Filed: Mar. 31, 2025

Related U.S. Application Data
(60) Provisional application No. 63/573,602, filed on Apr. 3, 2024.

(51) Int. Cl. G06N 3/08; G06N 3/0495

(52) U.S. Cl. CPC G06N 3/08; G06N 3/0495

(57) ABSTRACT

A correction method for quantized diffusion models is provided. The method includes quantizing a floating-point noise prediction network of a floating-point diffusion model to generate a quantized noise prediction network of the quantized diffusion model, measuring a quantization error associated with each sampling timestep in a sampling timestep sequence between the floating-point diffusion model and the quantized diffusion model using a calibration dataset, computing a corrected timestep sequence and an error mean sequence based on the measured quantization error associated with each sampling timestep, and using the quantized diffusion model to process input data based on the corrected timestep sequence and the error mean sequence to generate an output result.

### CROSS REFERENCE TO RELATED APPLICATIONS

This application claims the benefit of U.S. Provisional Application No. 63/573,602, filed Apr. 3, 2024, the entirety of which is incorporated by reference herein.

### BACKGROUND OF THE INVENTION

### Field of the Invention

The present invention relates to machine learning and diffusion models, and, in particular, to a system for correcting quantized diffusion models and the correction method thereof.

### Description of the Related Art

Diffusion models have emerged as a powerful generative approach across various applications, including image denoising, image synthesis, text generation, and audio generation. These models operate by progressively refining noisy inputs through an iterative denoising process, leveraging a learned noise prediction network. During the sampling process, the signal-to-noise ratio (SNR) of the produced images or latent representations exhibits a consistent, stepwise enhancement. In contrast to generative adversarial networks (GANs) and variational autoencoders (VAEs), which are prone to issues such as mode collapse and posterior collapse, diffusion models consistently produce diverse, high-quality samples, making them a predominant technique in generative modeling.

However, deploying diffusion models on computationally constrained devices, such as smartphones, is challenging due to their extensive computational demands. These demands arise from the complex network structures and the large number of iterative denoising steps required during sampling. To address these challenges and improve computational efficiency, model quantization has been explored as a viable solution.

Model quantization is a technique that reduces the memory footprint and computational cost of deep learning models by transitioning model parameters and activations from a high bit-width floating-point format to a more compact low bit-width representation. This transformation facilitates a substantial acceleration of model inference while maintaining a tolerable level of performance degradation.

However, the quantization process inevitably introduces numerical inaccuracies, known as quantization errors. In the context of diffusion models, the sampling procedure involves repetitive inference of the quantized model. Due to the iterative nature of the denoising process, quantization errors accumulate over multiple timesteps, leading to a progressive deviation from the ideal sampling trajectory. Although quantization errors at individual timesteps may appear insignificant, their cumulative effect can significantly degrade the quality of the generated results. This accumulation manifests as distortions in the final output, thereby diminishing the overall fidelity and robustness of the diffusion model.

A post-training quantization framework for diffusion models (PTQD) has been proposed to mitigate the adverse effects of quantization error accumulation in diffusion models. This approach involves adjusting the model's variance schedule to compensate for the quantization error at each timestep. While effectively integrating the quantization error into the noise estimation process, this approach is primarily designed for stochastic sampling techniques, limiting its applicability to deterministic samplers, such as denoising diffusion implicit models (DDIMs).

In view of the foregoing, it would be desirable to have a system for correcting quantized diffusion models and a corresponding correction method that effectively mitigates the accumulation of quantization errors while maintaining the computational efficiency of model quantization.

### BRIEF SUMMARY OF THE INVENTION

An embodiment of the present invention provides a correction method for a quantized diffusion model. The method is executed by a computer system. The method includes quantizing a floating-point noise prediction network of a floating-point diffusion model to generate a quantized noise prediction network of the quantized diffusion model, measuring a quantization error associated with each sampling timestep in a sampling timestep sequence between the floating-point diffusion model and the quantized diffusion model using a calibration dataset, computing a corrected timestep sequence and an error mean sequence based on the measured quantization error associated with each sampling timestep, and using the quantized diffusion model to process input data based on the corrected timestep sequence and the error mean sequence to generate an output result.

In an embodiment, measuring the quantization error includes performing the following operations. The operations includes inputting a corrected timestep and a floating-point latent variable that correspond to a current timestep in the sampling timestep sequence into the floating-point noise prediction network to obtain a predicted floating-point noise level. The operations further includes computing the floating-point latent variable that corresponds to a subsequent timestep following the current timestep, based on the predicted floating-point noise level and the floating-point latent variable that corresponds to the current timestep. The operations further includes inputting the corrected timestep and a quantized latent variable that correspond to the current timestep into the quantized noise prediction network to obtain a predicted quantized noise level. The operations further includes computing the quantized latent variable that corresponds to the subsequent timestep following the current timestep, based on the predicted quantized noise level and the quantized latent variable that corresponds to the current timestep. The operations further includes determining the quantization error associated with the subsequent timestep by computing the deviation between the floating-point latent variable and the quantized latent variable that correspond to the subsequent timestep.

In an embodiment, computing the corrected timestep sequence and the error mean sequence includes computing an error mean and an error variance of the quantization error associated with the subsequent timestep through statistical estimation under an assumption that the quantization error follows a Gaussian distribution, and determining the corrected timestep that corresponds to the subsequent timestep based on a signal retention hyperparameter and the error variance that are associated with the subsequent timestep.

In an embodiment, the method further includes determining whether the corrected timestep that corresponds to the subsequent timestep is greater than the subsequent timestep. In response to determining that the corrected timestep is greater than the subsequent timestep, adjusting the quantized latent variable corresponding to the subsequent timestep based on the error mean associated with the subsequent timestep, the signal retention hyperparameter associated with the subsequent timestep, and the signal retention hyperparameter associated with the corrected timestep, and setting the floating-point latent variable corresponding to the subsequent timestep to the adjusted quantized latent variable. In response to determining that the corrected timestep is not greater than the subsequent timestep, setting the error mean associated with the subsequent timestep to zero.

In an embodiment, the method further includes scaling the predicted floating-point noise level and the predicted quantized noise level corresponding to the current timestep by a step size. The step size is determined based on the signal retention hyperparameter of the corrected timestep corresponding to the current timestep.

In an embodiment, using the quantized diffusion model to process the input data based on the corrected timestep sequence and the error mean sequence to generate the output result includes initializing the input data as a quantized latent variable. Furthermore, following operations are iteratively performed, for each corrected timestep corresponding to a current timestep in the corrected timestep sequence. The operations includes inputting the corrected timestep and the quantized latent variable into the quantized noise prediction network to obtain a predicted quantized noise level. The operations further includes computing the quantized latent variable that corresponds to a subsequent timestep following the current timestep, based on the predicted quantized noise level and the quantized latent variable that corresponds to the current timestep. The operations further includes adjusting the quantized latent variable corresponding to the subsequent timestep based on an error mean associated with the subsequent timestep in the error mean sequence, a signal retention hyperparameter associated with the subsequent timestep, and the signal retention hyperparameter associated with the corrected timestep. Then, the output result is generated based on the quantized latent variable that corresponds to the final timestep after completing all iterations.

In an embodiment, using the quantized diffusion model to process the input data based on the corrected timestep sequence and the error mean sequence to generate the output result includes using the quantized diffusion model to process a noisy image based on the corrected timestep sequence and the error mean sequence to generate a denoised image.

In an embodiment, using the quantized diffusion model to process the input data based on the corrected timestep sequence and the error mean sequence to generate the output result includes using the quantized diffusion model to process an audio waveform with noise based on the corrected timestep sequence and the error mean sequence to generate a denoised audio waveform.

In an embodiment, using the quantized diffusion model to process the input data based on the corrected timestep sequence and the error mean sequence to generate the output result includes using the quantized diffusion model to process a random noise input based on the corrected timestep sequence and the error mean sequence to generate a synthesized image or a synthesized audio waveform.

In an embodiment, using the quantized diffusion model to process the input data based on the corrected timestep sequence and the error mean sequence to generate the output result includes using the quantized diffusion model to process a natural language prompt based on the corrected timestep sequence and the error mean sequence to generate a text sequence.

An embodiment of the present invention provides a system for correcting a quantized diffusion model. The system includes a processing unit and a storage unit. The storage unit is coupled to the processing unit, and is configured to store a computer program. The computer program includes instructions that, when executed by the processing unit, cause the processing unit to quantize a floating-point noise prediction network of a floating-point diffusion model to generate a quantized noise prediction network of the quantized diffusion model, measure a quantization error associated with each sampling timestep in a sampling timestep sequence between the floating-point diffusion model and the quantized diffusion model using a calibration dataset, compute a corrected timestep sequence and an error mean sequence based on the measured quantization error associated with each sampling timestep, and use the quantized diffusion model to process input data based on the corrected timestep sequence and the error mean sequence to generate an output result.

In an embodiment, the computer program causes the processing unit to measure the quantization error by performing the following operations. The operations includes inputting a corrected timestep and a floating-point latent variable that correspond to a current timestep in the sampling timestep sequence into the floating-point noise prediction network to obtain a predicted floating-point noise level. The operations further includes computing the floating-point latent variable that corresponds to a subsequent timestep following the current timestep, based on the predicted floating-point noise level and the floating-point latent variable that corresponds to the current timestep. The operations further includes inputting the corrected timestep and a quantized latent variable that correspond to the current timestep into the quantized noise prediction network to obtain a predicted quantized noise level. The operations further includes computing the quantized latent variable that corresponds to the subsequent timestep following the current timestep, based on the predicted quantized noise level and the quantized latent variable that corresponds to the current timestep. The operations further includes determining the quantization error associated with the subsequent timestep by computing the deviation between the floating-point latent variable and the quantized latent variable that correspond to the subsequent timestep.

In an embodiment, the computer program further causes the processing unit to compute the corrected timestep sequence and the error mean sequence by computing an error mean and an error variance of the quantization error associated with the subsequent timestep through statistical estimation under an assumption that the quantization error follows a Gaussian distribution, and determining the corrected timestep that corresponds to the subsequent timestep based on a signal retention hyperparameter and the error variance that are associated with the subsequent timestep.

In an embodiment, the computer program further causes the processing unit to determine whether the corrected timestep that corresponds to the subsequent timestep is greater than the subsequent timestep. In response to determining that the corrected timestep is greater than the subsequent timestep, the processing unit adjusts the quantized latent variable corresponding to the subsequent timestep based on the error mean associated with the subsequent timestep, the signal retention hyperparameter associated with the subsequent timestep, and the signal retention hyperparameter associated with the corrected timestep, and set the floating-point latent variable corresponding to the subsequent timestep to the adjusted quantized latent variable. In response to determining that the corrected timestep is not greater than the subsequent timestep, the processing unit sets the error mean associated with the subsequent timestep to zero.

In an embodiment, the computer program further causes the processing unit to scale the predicted floating-point noise level and the predicted quantized noise level corresponding to the current timestep by a step size. The step size is determined based on the signal retention hyperparameter of the corrected timestep corresponding to the current timestep.

In an embodiment, the computer program further causes the processing unit to initialize the input data as a quantized latent variable. The processing unit further performs the following operations iteratively, for each corrected timestep corresponding to a current timestep in the corrected timestep sequence. The operations includes inputting the corrected timestep and the quantized latent variable into the quantized noise prediction network to obtain a predicted quantized noise level. The operations further includes computing the quantized latent variable that corresponds to a subsequent timestep following the current timestep, based on the predicted quantized noise level and the quantized latent variable that corresponds to the current timestep. The operations further includes adjusting the quantized latent variable corresponding to the subsequent timestep based on an error mean associated with the subsequent timestep in the error mean sequence, a signal retention hyperparameter associated with the subsequent timestep, and the signal retention hyperparameter associated with the corrected timestep. Then, the processing unit generates the output result based on the quantized latent variable that corresponds to the final timestep after completing all iterations.

In an embodiment, the computer program further causes the processing unit to use the quantized diffusion model to process a noisy image based on the corrected timestep sequence and the error mean sequence to generate a denoised image.

In an embodiment, the computer program further causes the processing unit to use the quantized diffusion model to process an audio waveform with noise based on the corrected timestep sequence and the error mean sequence to generate a denoised audio waveform.

In an embodiment, the computer program further causes the processing unit to use the quantized diffusion model to process a random noise input based on the corrected timestep sequence and the error mean sequence to generate a synthesized image or a synthesized audio waveform.

In an embodiment, the computer program further causes the processing unit to use the quantized diffusion model to process a natural language prompt based on the corrected timestep sequence and the error mean sequence to generate a text sequence.

### BRIEF DESCRIPTION OF THE DRAWINGS

The present invention can be more fully understood by reading the subsequent detailed description and examples with references made to the accompanying drawings, wherein:

FIG. 1 is the system block diagram of a system for correcting quantized diffusion models, according to an embodiment of the present disclosure;

FIG. 2 is the flow diagram of a correction method for quantized diffusion models, according to an embodiment of the present disclosure;

FIG. 3 is the flow diagram of an implementation of measuring the quantization error, according to an embodiment of the present disclosure;

FIG. 4 is the flow diagram of an implementation of computing the corrected timestep sequence and the error mean sequence, according to an embodiment of the present disclosure;

FIG. 5 is the flow diagram of an implementation of latent adjustment, according to an embodiment of the present disclosure;

FIG. 6 is the flow diagram of an implementation of the inference stage of the quantized diffusion model, according to an embodiment of the present disclosure;

FIG. 7A illustrates the denoising trajectory in a floating-point diffusion model;

FIG. 7B illustrates the denoising trajectory in a conventional quantized diffusion model; and

FIG. 7C illustrates the denoising trajectory in the corrected quantized diffusion model, according to an embodiment of the present disclosure

### DETAILED DESCRIPTION OF THE INVENTION

The following description is made for the purpose of illustrating the general principles of the invention and should not be taken in a limiting sense. The scope of the invention is best determined by reference to the appended claims.

In each of the following embodiments, the same reference numbers represent identical or similar elements or components.

Ordinal terms used in the claims, such as “first,” “second,” “third,” etc., are only for convenience of explanation, and do not imply any precedence relation between one another.

The descriptions provided below for embodiments of devices or systems are also applicable to embodiments of methods, and vice versa.

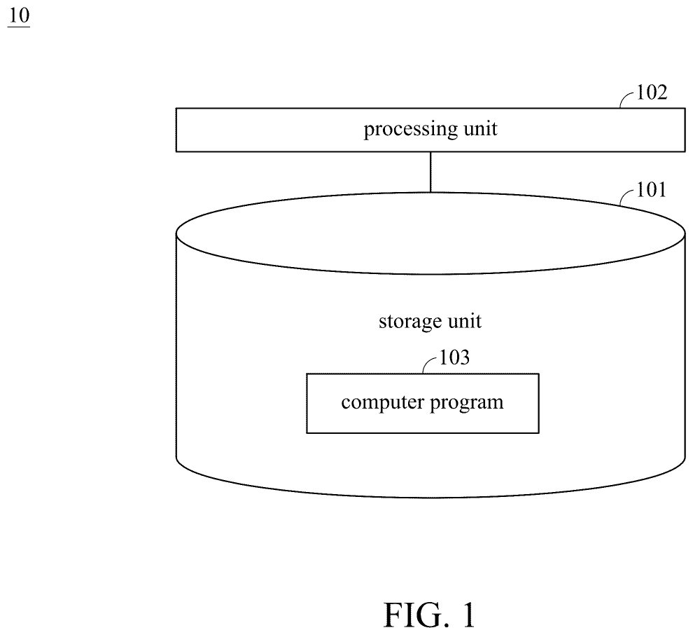

FIG. 1 is the system block diagram of a system 10 for correcting quantized diffusion models, according to an embodiment of the present disclosure. As shown in FIG. 1, the system 10 includes a storage unit 101 and a processing unit 102.

The system 10 can be implemented using any computer system with computing capabilities, such as a personal computer (e.g., a desktop or laptop computer) or a server computer running an operating system (e.g., Windows, Mac OS, Linux, or UNIX). Alternatively, the 10 can also be a mobile device such as a tablet or smartphone, but the present disclosure is not limited thereto.

The storage unit 101 may include one or more non-transitory computer-readable storage media that contain non-volatile memory, such as read-only memory (ROM), electrically-erasable programmable read-only memory (EEPROM), flash memory, or non-volatile random-access memory (NVRAM). These storage media may include, but are not limited to, hard disk drives (HDD), solid-state drives (SSD), optical disks, or any combination thereof.

The processing unit 102 may include one or more general-purpose or specialized processors, or a combination thereof, capable of executing instructions. The processing unit 102 may further include volatile memory such as Random Access Memory (RAM), Dynamic Random Access Memory (DRAM), and/or other types of high-speed memory, which work in conjunction with the processors to store and quickly access data and instructions during execution.

In an embodiment, the processing unit 102 includes a Central Processing Unit (CPU) and a Graphics Processing Unit (GPU). A GPU is specifically designed to perform computer graphics calculations and image analysis, making it more efficient for these tasks compared to a general-purpose CPU. Therefore, tasks may be assigned based on the characteristics of the CPU and GPU, such as assigning tasks related to data acquisition or communication with other devices to the CPU and tasks related to computer graphics calculations and image analysis to the GPU. In further embodiments, the processing unit 102 may further include a Neural Processing Unit (NPU), which is optimized for deep learning. Compared to a GPU, an NPU may offer superior computational performance for tasks related to the training and inference of a deep learning model. Therefore, in these embodiments, operations involving model training and inference can be assigned to the NPU to achieve improved efficiency and performance.

As shown in FIG. 1, the storage unit 101 stores a computer program 103, which can be written in any known programming language, such as Python, C++, or Java. This computer program 103 contains instructions that, when executed by the processing unit 102, cause the system 10 to perform steps or operations of the correction method for quantized diffusion models disclosed herein.

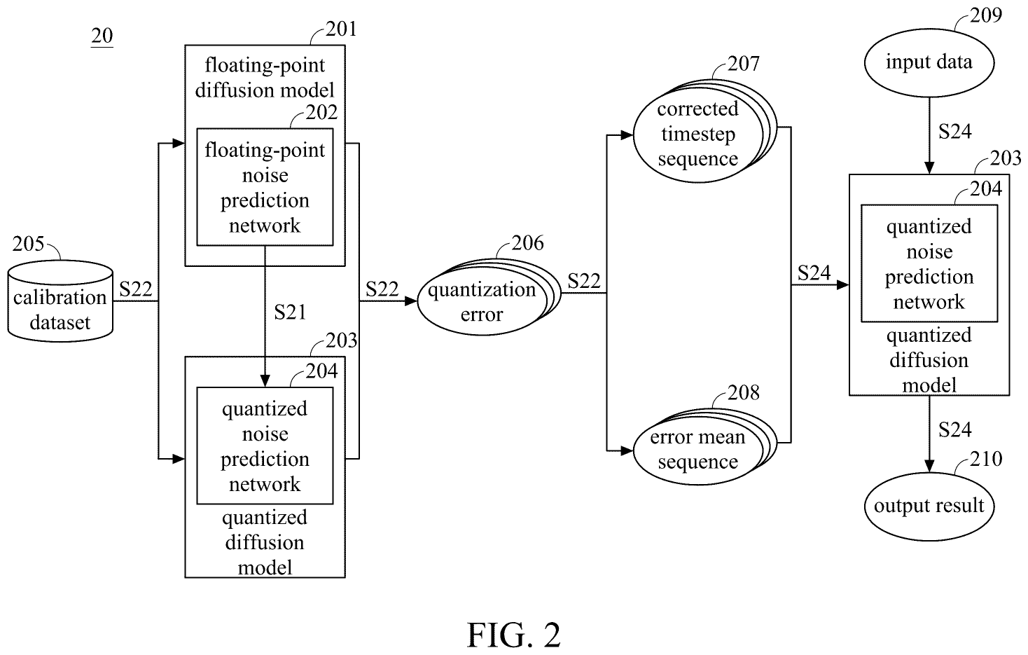

FIG. 2 is the flow diagram of a correction method 20 for quantized diffusion models, according to an embodiment of the present disclosure. As illustrated in FIG. 2, the correction method includes steps S21-S24. Each of these steps will be elaborated below.

In step S21, the floating-point noise prediction network 202 of the floating-point diffusion model 201 is quantized, generating the quantized noise prediction network 204 of the quantized diffusion model 203.

More specifically, the quantization process involves transforming the parameters and activations of the floating-point noise prediction network 202 from a high-precision floating-point representation to a lower-bit-width format, reducing memory consumption and computational complexity. This transformation allows the quantized noise prediction network 204 to approximate the function of the original floating-point noise prediction network 202 while enabling efficient execution on resource-constrained hardware.

The quantized noise prediction network 204 operates with reduced numerical precision compared to the floating-point noise prediction network 202, which may introduce minor discrepancies in noise prediction. These discrepancies, known as quantization errors, can accumulate throughout the iterative denoising process, potentially affecting the quality of generated outputs. Therefore, subsequent steps S22 and S23 are presented to address the quantization errors.

In step S22, a quantization error 206 associated with each sampling timestep in a sampling timestep sequence between the floating-point diffusion model 201 and the quantized diffusion model 203 is measured using a calibration dataset 205.

The quantization error 206 represents the deviation between the outputs of the floating-point noise prediction network 202 and the quantized noise prediction network 204 at each sampling timestep. Since diffusion models rely on iterative sampling, even small discrepancies in noise prediction can propagate over multiple timesteps, leading to accumulated deviations in the sampling trajectory.

To measure the quantization error 206 effectively, a calibration dataset 205 is used. This dataset consists of representative data samples that enable the system to evaluate how the quantized diffusion model 203 behaves in comparison to the floating-point diffusion model 201. By analyzing the differences in noise predictions over multiple timesteps, a comprehensive profile of the quantization error 206 can be obtained.

In step S23, a corrected timestep sequence 207 and an error mean sequence 208 are computed based on the measured quantization error 206 associated with each sampling timestep.

The corrected timestep sequence 207 represents an adjustment to the original sampling timesteps to compensate for the accumulated quantization error 206. This adjustment ensures that the sampling process remains as close as possible to the intended trajectory of the floating-point diffusion model 201, despite the approximations introduced by quantization.

The error mean sequence 208 captures the average effects of quantization error 206 across timesteps. Since diffusion models rely on stepwise noise prediction and removal, quantization error can systematically alter the expected noise distribution over time. By computing an error mean sequence 208, the system can account for these systematic shifts and apply appropriate corrections.

The corrected timestep sequence 207 and the error mean sequence 208 together serve as key parameters in the subsequent inference phase, enabling the quantized diffusion model 203 to operate with improved alignment to the original floating-point diffusion model 201.

In step S24, the quantized diffusion model 203 is used to process input data 209 based on the corrected timestep sequence 207 and the error mean sequence 208 to generate an output result 210.

Step 24 corresponds to the inference phase of the quantized diffusion model 203, where the quantized diffusion model 203 takes input data 209 and iteratively refines it over multiple timesteps to produce the final output result 210. However, instead of using the original timesteps from the floating-point diffusion model 201, the corrected timestep sequence 207, which is computed in the correction phase (i.e., steps S22 to S23), is used as input to the quantized noise prediction network 204.

By incorporating the corrected timestep sequence 207 and the error mean sequence 208, the inference process effectively accounts for the quantization error 206 accumulated during the denoising process. Since the corrected timesteps have been adjusted to reflect the impact of quantization, they tend to be slightly shifted backward compared to the original timesteps. This backward shift empowers the quantized noise prediction network 204 to make more accurate predictions in the noise level at each timestep, allowing the quantized diffusion model 203 to follow a more accurate sampling trajectory.

The corrected and enhanced quantized diffusion model 203 can be integrated into various practical applications, including but not limited to image denoising, image synthesis, text generation, and audio generation. Therefore, the input data 209 and the output result 210 may correspond to different data modalities depending on the application scenario. For instance, the input data 209 may include a noisy visual or auditory signal, a random noise pattern, or a natural language prompt, while the output result 210 may correspondingly be a denoised or synthesized version of such signal, or a generated text sequence. The flexibility of the quantized diffusion model 203 allows it to serve as a general-purpose generative engine across visual, auditory, and linguistic domains.

In an embodiment, the quantized diffusion model 203 is applied in image denoising. In this application, the input data 209 is a noisy image, and the output result 210 is a denoised image. In other words, step S24 involves using the quantized diffusion model 203 to process the noisy image based on the corrected timestep sequence 207 and the error mean sequence 208 to generate the denoised image. The quantization-error-aware corrections introduced in the model ensure that fine-grained textures and details can be restored with minimal degradation, even under low-precision inference constraints.

In another embodiment, the quantized diffusion model 203 is applied in audio denoising. In this application, the input data 209 is an audio waveform with noise, and the output result 210 is a denoised audio waveform. In other words, step S24 involves using the quantized diffusion model 203 to process the audio waveform with noise based on the corrected timestep sequence 207 and the error mean sequence 208 to generate the denoised audio waveform. The correction method facilitates the preservation of subtle acoustic features, enabling real-time deployment in low-resource edge devices such as mobile or embedded systems.

In another embodiment, the quantized diffusion model 203 is applied in image or audio synthesis. In this application, the input data 209 is a random noise, such as a noise map or a noise signal, and the output result 210 is a synthesized image or a synthesized audio waveform. In other words, step S24 involves using the quantized diffusion model 203 to process the random noise based on the corrected timestep sequence 207 and the error mean sequence 208 to generate the synthesized image or the synthesized audio waveform. The corrections and improvements introduced in the quantized diffusion model 203 enable stable generative quality, even under aggressive quantization levels such as INT8 or INT4.

In yet another embodiment, the quantized diffusion model 203 is applied in text generation. In this application, the input data 209 is a natural language prompt, such as a question or an incomplete sentence, and the output result 210 is a text sequence. In other words, step S24 involves using the quantized diffusion model 203 to process the natural language prompt based on the corrected timestep sequence 207 and the error mean sequence 208 to generate the text sequence. In this context, the quantized diffusion model 203 may correspond to a compact variant of a large language model (LLM), designed to operate under constrained memory and computation budgets while maintaining fluency and contextual coherence in the generated text.

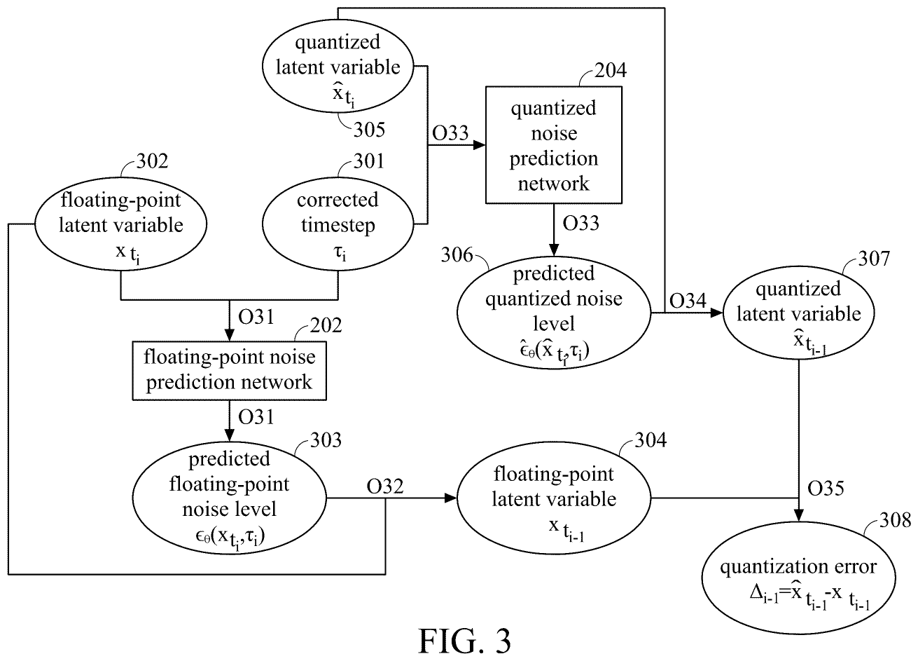

FIG. 3 is the flow diagram of an implementation of measuring the quantization error 206 in step S22 of FIG. 2, according to an embodiment of the present disclosure. As illustrated in FIG. 3, step S22 may include operations O31-O35. Each of these operations will be elaborated below.

Operation O31 involves inputting a corrected timestep 301 (mathematically denoted as τᵢ) and a floating-point latent variable 302 (mathematically denoted as xₜ_{ᵢ}) that correspond to a current timestep tᵢ in the sampling timestep sequence into the floating-point noise prediction network 202 to obtain a predicted floating-point noise level 303, mathematically denoted as ∈₇₄ (xₜ_{ᵢ}, τᵢ).

The floating-point latent variable 302 represents an intermediate data state during the iterative denoising process of the floating-point diffusion model. The floating-point noise prediction network 202 is responsible for estimating the noise component present in the floating-point latent variable 302 at the given timestep tᵢ, which serves as a critical step in progressively refining the data towards its final denoised state.

Operation O32 involves computing the floating-point latent variable 304 (mathematically denoted as xₜ_{_{i−1}}) that corresponds to a subsequent timestep tᵢ₋₁ following the current timestep tᵢ, based on the predicted floating-point noise level 303 and the floating-point latent variable 302 that corresponds to the current timestep tᵢ.

It should be appreciated that in the context of diffusion models, the term “subsequent timestep” refers to the progression in the reverse diffusion process, meaning that the timestep index i decreases as the denoising process unfolds. Instead of incrementally adding noise, diffusion models iteratively removes estimated noise components, thereby guiding the latent variable closer to its final clean representation.

Operation O33 involves inputting the corrected timestep 301 (mathematically denoted as τᵢ) and a quantized latent variable 305 (mathematically denoted as \hat{x}ₜ_{ᵢ}) that correspond to the current timestep tᵢ into the quantized noise prediction network 204 to obtain a predicted quantized noise level 306, mathematically denoted as \hat{∈}_{θ}(\hat{x}ₜ_{ᵢ}, τᵢ).

The quantized latent variable 305 represents an approximation of the floating-point latent variable 302 after being processed through a quantization scheme. The quantized noise prediction network 204 operates similarly to the floating-point noise prediction network 202 but is adapted to handle the quantized data representation, which may introduce additional distortions due to precision loss.

Operation O34 involves computing the quantized latent variable 307 (mathematically denoted as \hat{x}ₜ_{_{i−1}}) that corresponds to the subsequent timestep tᵢ₋₁ following the current timestep tᵢ, based on the predicted quantized noise level 306 and the quantized latent variable 305 that corresponds to the current timestep tᵢ.

This operation follows a similar denoising trajectory as in the floating-point case, but since the quantized noise prediction network 204 operates on a lower-precision representation, the quantized latent variable 307 may exhibit deviations from its floating-point counterpart (i.e., floating-point latent variable 304), leading to quantization errors.

Operation O35 involves determining the quantization error 308 (mathematically denoted as Δᵢ₋₁) associated with the subsequent timestep tᵢ₋₁ by computing the deviation between the floating-point latent variable 304 and the quantized latent variable 307 that correspond to the subsequent timestep tᵢ₋₁.

The computation involved in operation O35 can be mathematically expressed as Δᵢ₋₁=\hat{x}ₜ_{_{i−1}}−xₜ_{_{i−1}}. The quantization error 308 provides a measure of how much the quantized diffusion process deviates from the original floating-point process at each timestep, which is later utilized to adjust the sampling trajectory and compensate for accumulated quantization errors.

As illustrated in FIG. 3, both the floating-point noise prediction network 202 and the quantized noise prediction network 204 receive the corrected timestep 301 as input instead of the original timestep. This improvement will be referred to as “temporal information alignment” hereinafter. Specifically, temporal information alignment is implemented by replacing the original sampling timestep tᵢ with the corrected timestep 301 (τᵢ) when inputting data into the noise prediction networks. This adjustment accounts for the increased noise level present in the quantized latent variable 305 (\hat{x}ₜ_{ᵢ}) compared to its floating-point counterpart, the floating-point latent variable 302 (xₜ_{ᵢ}). By ensuring that the temporal information input aligns with the actual noise characteristics of the latent variables, the noise prediction network can generate more accurate noise level predictions, thereby reducing the impact of accumulated quantization errors in subsequent timesteps.

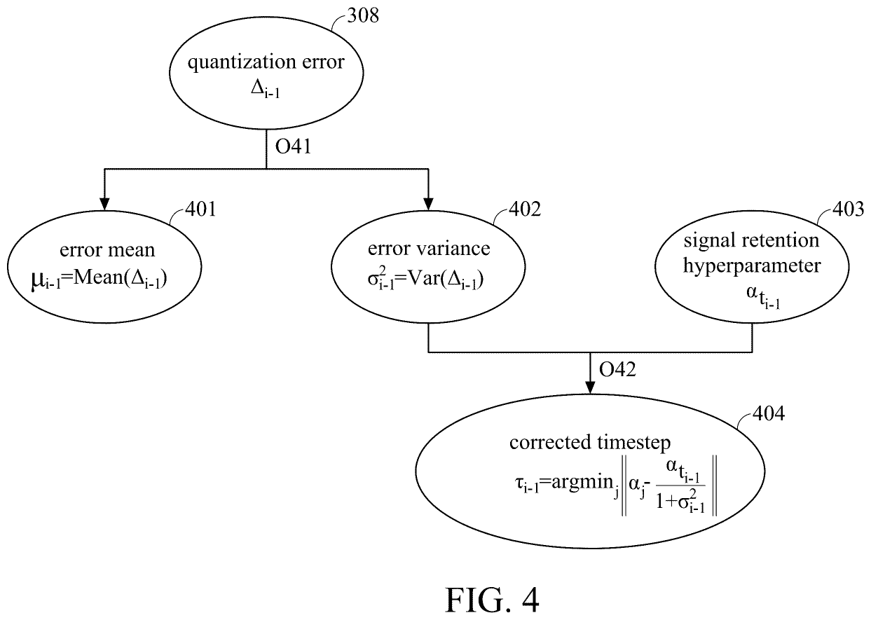

FIG. 4 is the flow diagram of an implementation of computing the corrected timestep sequence 207 and the error mean sequence 208 in step S23 of FIG. 2, according to an embodiment of the present disclosure. As illustrated in FIG. 4, step S23 may include operations O41 and O42. Each of these operations will be elaborated below.

Operation O41 involves computing an error mean 401 (mathematically denoted as μᵢ₋₁) and an error variance 402 (mathematically denoted as

$${σ}_{i - 1}^{2} )$$

of the quantization error 308 (Δᵢ₋₁) associated with the subsequent timestep tᵢ₋₁ through statistical estimation under an assumption that the quantization error 308 follows a Gaussian distribution.

The error mean 401 represents the expected deviation between the quantized latent variable and the floating-point latent variable at the given timestep, providing a measure of systematic bias introduced by the quantization process. The error variance 402 represents the variability of the quantization error, indicating the extent to which the error fluctuates across different samples. These statistical metrics serve as key factors in adjusting the sampling trajectory to mitigate accumulated quantization errors.

Operation O42 involves determining the corrected timestep 404 (mathematically denoted as τᵢ₋₁) that corresponds to the subsequent timestep tᵢ₋₁ based on a signal retention hyperparameter 403 (mathematically denoted as αₜ_{_{i−1}}) and the error variance 402 that are associated with the subsequent timestep tᵢ₋₁.

The computation involved in operation O42 can be mathematically expressed as

$${τ}_{i - 1} = arg {min}_{j} ‖ {α}_{j} - \frac{{α}_{{t}_{i - 1}}}{1 + {σ}_{i - 1}^{2}} ‖ .$$

The signal retention hyperparameter 403 (αₜ_{_{i−1}}) represents a predefined parameter that governs the retention of signal information during the denoising process, influencing the step size of the reverse diffusion trajectory. The corrected timestep 404 is selected to minimize the deviation between the target signal retention level and the adjusted signal retention level, which accounts for the impact of the quantization variance.

Notably, once computed, the corrected timestep 404 is propagated forward in the next iteration and serves as the corrected timestep 301 in FIG. 3, where it is used to compute the quantization error at the next timestep.

In an embodiment, to approximate the quantized latent variable \hat{x}tᵢ as though it were sampled from the distribution at the τᵢ-th step, a further adjustment is made to align their distributions. This adjustment effectively bridges the distribution shift and improves the noise prediction results, and will be referred to as “latent adjustment” hereinafter.

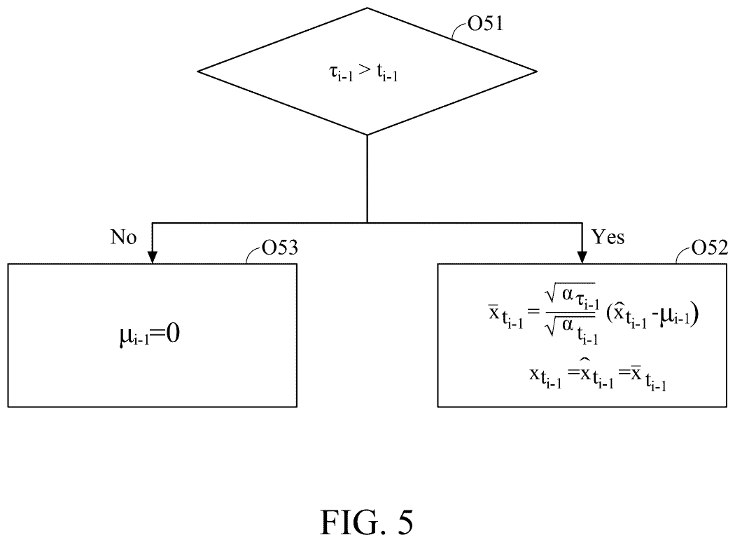

FIG. 5 is the flow diagram of an implementation of latent adjustment, according to an embodiment of the present disclosure. As illustrated in FIG. 5, latent adjustment may include operations O51-O53. Each of these operations will be elaborated below.

Operation O51 involves determining whether the corrected timestep τᵢ₋₁ that corresponds to the subsequent timestep tᵢ₋₁ is greater than the subsequent timestep tᵢ₋₁. If the corrected timestep τᵢ₋₁ is greater than the subsequent timestep tᵢ₋₁, meaning that the accumulated quantization error has grown sufficiently large such that

$$arg {min}_{j} ‖ {α}_{j} - \frac{{α}_{{t}_{i - 1}}}{1 + {σ}_{i - 1}^{2}} ‖$$

deviates from the original timestep tᵢ₋₁, then operation O52 is performed. Otherwise, operation O53 is performed.

Operation O52 involves adjusting the quantized latent variable \hat{x}ₜ_{_{i−1}} corresponding to the subsequent timestep tᵢ₋₁ based on the error mean μₜ_{_{i−1}} associated with the subsequent timestep tᵢ₋₁, the signal retention hyperparameter αₜ_{_{i−1}} associated with the subsequent timestep tᵢ₋₁, and the signal retention hyperparameter α_{τ}_{_{i−1}} associated with the corrected timestep τᵢ₋₁, generating the adjusted quantized latent variable x̅ₜ_{_{i−1}}. Then, both the original quantized latent variable \hat{x}ₜ_{_{i−1}} and the floating-point latent variable xₜ_{_{i−1}} corresponding to the subsequent timestep tᵢ₋₁ are set to the adjusted quantized latent variable x̅ₜ_{_{i−1}}.

Specifically, the channel-wise mean of quantization error is subtracted from the quantized latent variable, and then the result is rescaled by a factor

$$\frac{\sqrt{{α}_{{τ}_{i - 1}}}}{\sqrt{{α}_{{t}_{i - 1}}}} .$$

This adjustment involved in operation O52 can be mathematically expressed as follows:

$$\begin{matrix}{\overline{x}}_{{t}_{i - 1}} = \frac{\sqrt{{α}_{{τ}_{i - 1}}}}{\sqrt{{α}_{{t}_{i - 1}}}} ( {\hat{x}}_{{t}_{i - 1}} - {μ}_{i - 1} ) \\ {x}_{{t}_{i - 1}} = {\hat{x}}_{{t}_{i - 1}} = {\overline{x}}_{{t}_{i - 1}}\end{matrix}$$

Operation O53 involves setting the error mean μᵢ₋₁ associated with the subsequent timestep tᵢ₋₁ to zero. This operation indicates that the quantization error at this timestep does not cause a significant deviation in the sampling trajectory, thus no latent adjustment is necessary.

In an embodiment, considering the fact that the quantization errors increase the variance of quantized latent variables and decrease the signal-to-noise ratio (SNR), defined as

$$SNR = \frac{{μ}^{2}}{{σ}^{2}} ,$$

which enlarges the distance between the quantized latent variable and the final result, the step size at each timestep is extended to compensate the increased distance. This extension can be realized by substituting the original step size \sqrt{1−αₜ_{ᵢ}} with \sqrt{1−α_{τ}_{ᵢ}}. The adjusted step size is longer than or equal to the original one, owing to the relationship α_{τ}_{ᵢ}≤αₜ_{ᵢ}. This further improvement will be referred to as “step size adaption” hereinafter.

Specifically, in this embodiment, the predicted floating-point noise level ∈_{θ}(xₜ_{ᵢ}, τᵢ) and the predicted quantized noise level \hat{∈}_{θ}(\hat{x}ₜ_{ᵢ}, τᵢ) corresponding to the current timestep tᵢ are both scaled by a step size determined based on the signal retention hyperparameter α_{τ}_{ᵢ} of the corrected timestep τᵢ corresponding to the current timestep tᵢ. By integrating the aforementioned “temporal alignment,” “latent adjustment,” and “step size adaption,” the quantized latent variable corresponding to the subsequent timestep tᵢ₋₁ can be mathematically expressed as follows:

$${\hat{x}}_{{t}_{i - 1}} = \sqrt{{α}_{{t}_{i - 1}}} ( \frac{{\hat{x}}_{{t}_{i}} - \sqrt{1 - {α}_{{τ}_{i}}} {\hat{ϵ}}_{θ} ( {\hat{x}}_{{t}_{i}} , {τ}_{i} )}{\sqrt{{α}_{{τ}_{i}}}} ) + \sqrt{1 - {α}_{{t}_{i - 1}}} {\hat{ϵ}}_{θ} ( {\hat{x}}_{{t}_{i}} , {τ}_{i} )$$

Similarly, the floating-point latent variable corresponding to the subsequent timestep tᵢ₋₁ can be can be mathematically expressed as follows:

$${x}_{{t}_{i - 1}} = \sqrt{{α}_{{t}_{i - 1}}} ( \frac{{x}_{{t}_{i}} - \sqrt{1 - {α}_{{τ}_{i}}} {ϵ}_{θ} ( {x}_{{t}_{i}} , {τ}_{i} )}{\sqrt{{α}_{{τ}_{i}}}} ) + \sqrt{1 - {α}_{{t}_{i - 1}}} {ϵ}_{θ} ( {x}_{{t}_{i}} , {τ}_{i} )$$

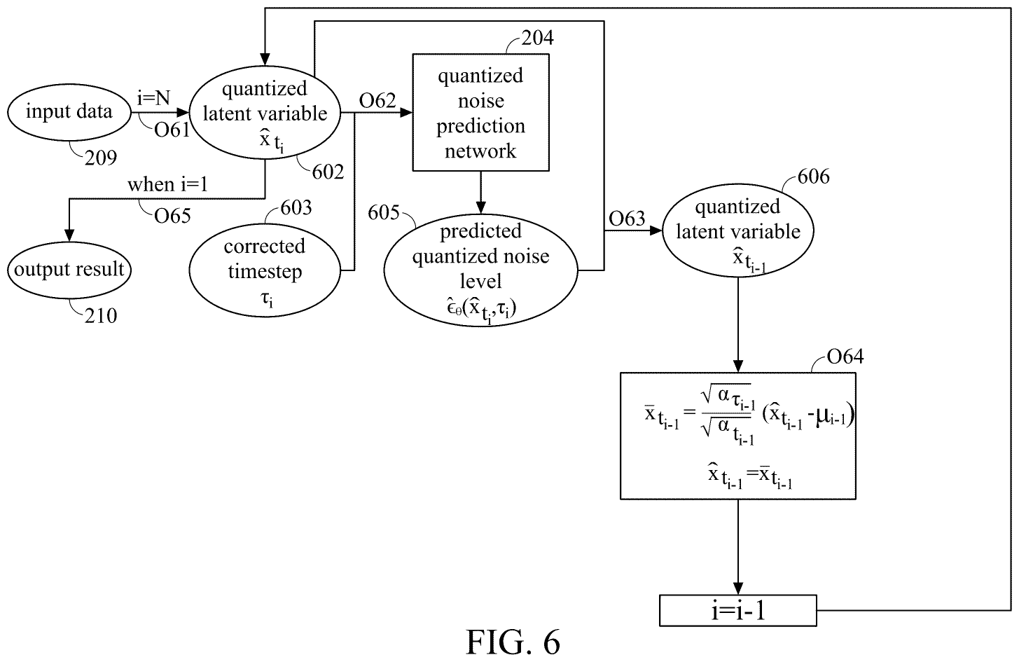

FIG. 6 is the flow diagram of an implementation of the inference stage of the quantized diffusion model, which corresponds to processing the input data 209 and generating the output result 210 in step S24 of FIG. 2, according to an embodiment of the present disclosure. As illustrated in FIG. 6, the inference stage of the quantized diffusion model may include operations O61-O65. Each of these operations will be elaborated below.

Operation O61 involves initializing the input data 209 as a quantized latent variable \hat{x}ₜ_{ᵢ}, where i is set equal to the total number of timesteps N. Subsequently, operations O62-O66 are iteratively performed, for each corrected timestep τᵢ corresponding to the current timestep tᵢ in the corrected timestep sequence.

Operation O62 involves inputting the corrected timestep 603 (τᵢ) and the quantized latent variable 602 (\hat{x}ₜ_{ᵢ}) into the quantized noise prediction network 204 to obtain the predicted quantized noise level 605, mathematically denoted as \hat{∈}₇₄ (\hat{x}ₜ_{ᵢ}, τᵢ).

Operation O63 involves computing the quantized latent variable 606 (\hat{x}ₜ_{_{i−1}}) that corresponds to the subsequent timestep tᵢ₋₁ following the current timestep tᵢ, based on the predicted quantized noise level 605 and the quantized latent variable 602 (\hat{x}ₜ_{ᵢ}) that corresponds to the current timestep tᵢ.

Operation O64 involves adjusting the quantized latent variable \hat{x}ₜ_{_{i−1}} corresponding to the subsequent timestep tᵢ₋₁ based on the error mean μᵢ₋₁ associated with the subsequent timestep tᵢ₋₁, the signal retention hyperparameter αₜ_{_{i−1}} associated with the subsequent timestep tᵢ₋₁, and the signal retention hyperparameter \hat{α}_{τ}_{_{i−1}} associated with the corrected timestep τᵢ₋₁. Specifically, this adjustment in operation O64 can be mathematically expressed as follows:

$$\begin{matrix}{\overline{x}}_{{t}_{i - 1}} = \frac{\sqrt{{α}_{{τ}_{i - 1}}}}{\sqrt{{α}_{{t}_{i - 1}}}} ( {\hat{x}}_{{t}_{i - 1}} - {μ}_{i - 1} ) \\ {\hat{x}}_{{t}_{i - 1}} = {\overline{x}}_{{t}_{i - 1}}\end{matrix}$$

After completing operations O62-O64 for the current timestep tᵢ, the timestep index i is decremented by 1, and the process returns to operation O62. This iterative loop continues until i reaches 1, at which point operation O65 is performed.

Operation O65 involves generating the output result 210 based on the quantized latent variable 602 (\hat{x}₁), which corresponds to the final timestep t₁, after completing all iterations.

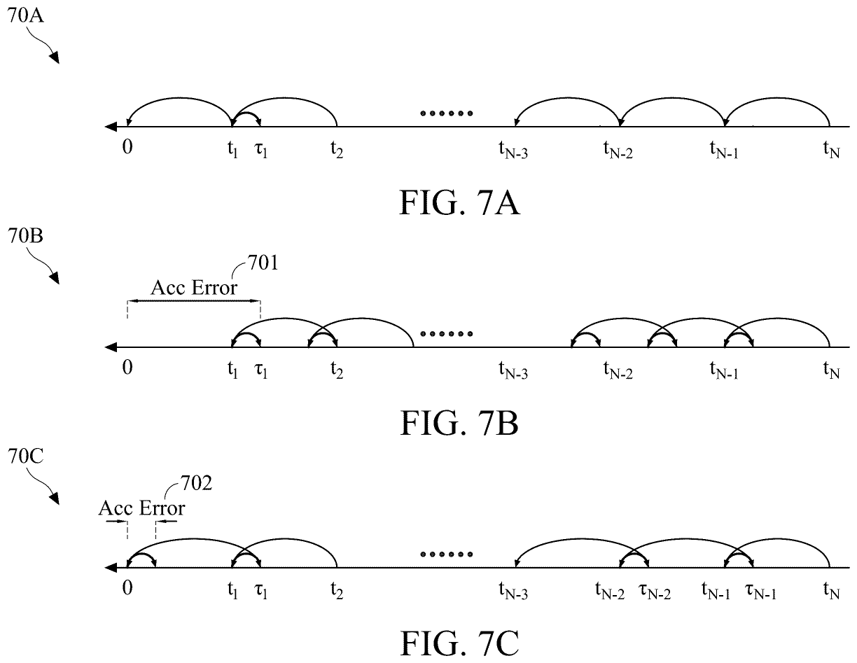

FIG. 7A, FIG. 7B, and FIG. 7C illustrate the denoising trajectories in three different diffusion models: the floating-point diffusion model 70A, the conventional quantized diffusion model 70B, and the corrected quantized diffusion model 70C, respectively. These diagrams represent the evolution of the latent variable over multiple timesteps, demonstrating how quantization affects the sampling process and how the proposed improvements mitigate accumulated quantization errors.

FIG. 7A demonstrates the ideal denoising process in the floating-point diffusion model 70A, where each timestep follows a smooth trajectory toward the final clean output. The latent variable progresses consistently through the timesteps without quantization errors. This serves as the baseline against which the quantized models are compared.

FIG. 7B demonstrates the impact of quantization in the conventional quantized diffusion model 70B. As the denoising process progresses, the latent variable deviates from its intended trajectory, leading to a significant accumulated quantization error 701 at the final timestep. The accumulation of quantization gradually propagate, causing the overall sampling trajectory to drift further away from the ideal path. As a result, the final output may suffer from quality degradation, with increased distortion due to misalignment with the floating-point model.

FIG. 7C showcases the improved performance of the corrected quantized diffusion model 70C disclosed herein, incorporating temporal alignment, latent adjustment, and step size adaptation to counteract the accumulation of quantization errors. Compared to the conventional quantized diffusion model 70B, the corrected quantized diffusion model 70C significantly reduces the deviation at each timestep, allowing the latent variable to follow a trajectory much closer to that of the floating-point model diffusion 70A. Although a small error 702 remains at the final timestep, its magnitude is minimal so the impact to the final result is basically negligible. By incorporating temporal alignment, latent adjustment, and step size adaptation, the proposed method effectively restores a more stable sampling trajectory, leading to a final result with far less distortion than the conventional quantized model 70B.

The above paragraphs are described with multiple aspects. Obviously, the teachings of the specification may be performed in multiple ways. Any specific structure or function disclosed in examples is only a representative situation. According to the teachings of the specification, it should be noted by those skilled in the art that any aspect disclosed may be performed individually, or that more than two aspects could be combined and performed.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A correction method for a quantized diffusion model, executed by a computer system, the method comprising:
quantizing a floating-point noise prediction network of a floating-point diffusion model to generate a quantized noise prediction network of the quantized diffusion model;
measuring a quantization error associated with each sampling timestep in a sampling timestep sequence between the floating-point diffusion model and the quantized diffusion model using a calibration dataset;
computing a corrected timestep sequence and an error mean sequence based on the measured quantization error associated with each sampling timestep; and
using the quantized diffusion model to process input data based on the corrected timestep sequence and the error mean sequence to generate an output result.

2. The method as claimed in claim 1, wherein measuring the quantization error comprises:
inputting a corrected timestep and a floating-point latent variable that correspond to a current timestep in the sampling timestep sequence into the floating-point noise prediction network to obtain a predicted floating-point noise level;
computing the floating-point latent variable that corresponds to a subsequent timestep following the current timestep, based on the predicted floating-point noise level and the floating-point latent variable that corresponds to the current timestep;
inputting the corrected timestep and a quantized latent variable that correspond to the current timestep into the quantized noise prediction network to obtain a predicted quantized noise level;
computing the quantized latent variable that corresponds to the subsequent timestep following the current timestep, based on the predicted quantized noise level and the quantized latent variable that corresponds to the current timestep; and
determining the quantization error associated with the subsequent timestep by computing a deviation between the floating-point latent variable and the quantized latent variable that correspond to the subsequent timestep.

3. The method as claimed in claim 2, wherein computing the corrected timestep sequence and the error mean sequence comprises:
computing an error mean and an error variance of the quantization error associated with the subsequent timestep through statistical estimation under an assumption that the quantization error follows a Gaussian distribution; and
determining the corrected timestep that corresponds to the subsequent timestep based on a signal retention hyperparameter and the error variance that are associated with the subsequent timestep.

4. The method as claimed in claim 3, further comprising:
determining whether the corrected timestep that corresponds to the subsequent timestep is greater than the subsequent timestep;
in response to determining that the corrected timestep is greater than the subsequent timestep, adjusting the quantized latent variable corresponding to the subsequent timestep based on the error mean associated with the subsequent timestep, the signal retention hyperparameter associated with the subsequent timestep, and the signal retention hyperparameter associated with the corrected timestep, and setting the floating-point latent variable corresponding to the subsequent timestep to the adjusted quantized latent variable; and
in response to determining that the corrected timestep is not greater than the subsequent timestep, setting the error mean associated with the subsequent timestep to zero.

5. The method as claimed in claim 3, further comprising scaling the predicted floating-point noise level and the predicted quantized noise level corresponding to the current timestep by a step size;
wherein the step size is determined based on the signal retention hyperparameter of the corrected timestep corresponding to the current timestep.

6. The method as claimed in claim 1, wherein using the quantized diffusion model to process the input data based on the corrected timestep sequence and the error mean sequence to generate the output result comprises:
initializing the input data as a quantized latent variable;
iteratively, for each corrected timestep corresponding to a current timestep in the corrected timestep sequence:
inputting the corrected timestep and the quantized latent variable into the quantized noise prediction network to obtain a predicted quantized noise level;
computing the quantized latent variable that corresponds to a subsequent timestep following the current timestep, based on the predicted quantized noise level and the quantized latent variable that corresponds to the current timestep;
adjusting the quantized latent variable corresponding to the subsequent timestep based on an error mean associated with the subsequent timestep in the error mean sequence, a signal retention hyperparameter associated with the subsequent timestep, and the signal retention hyperparameter associated with the corrected timestep; and
generating the output result based on the quantized latent variable that corresponds to a final timestep after completing all iterations.

7. The method as claimed in claim 1, wherein using the quantized diffusion model to process the input data based on the corrected timestep sequence and the error mean sequence to generate the output result comprises:
using the quantized diffusion model to process a noisy image based on the corrected timestep sequence and the error mean sequence to generate a denoised image.

8. The method as claimed in claim 1, wherein using the quantized diffusion model to process the input data based on the corrected timestep sequence and the error mean sequence to generate the output result comprises:
using the quantized diffusion model to process an audio waveform with noise based on the corrected timestep sequence and the error mean sequence to generate a denoised audio waveform.

9. The method as claimed in claim 1, wherein using the quantized diffusion model to process the input data based on the corrected timestep sequence and the error mean sequence to generate the output result comprises:
using the quantized diffusion model to process a random noise input based on the corrected timestep sequence and the error mean sequence to generate a synthesized image or a synthesized audio waveform.

10. The method as claimed in claim 1, wherein using the quantized diffusion model to process the input data based on the corrected timestep sequence and the error mean sequence to generate the output result comprises:
using the quantized diffusion model to process a natural language prompt based on the corrected timestep sequence and the error mean sequence to generate a text sequence.

11. A system for correcting a quantized diffusion model, comprising:
a processing unit; and
a storage unit, coupled to the processing unit, and configured to store a computer program comprising instructions that, when executed by the processing unit, cause the processing unit to:
quantize a floating-point noise prediction network of a floating-point diffusion model to generate a quantized noise prediction network of the quantized diffusion model;
measure a quantization error associated with each sampling timestep in a sampling timestep sequence between the floating-point diffusion model and the quantized diffusion model using a calibration dataset;
compute a corrected timestep sequence and an error mean sequence based on the measured quantization error associated with each sampling timestep; and
use the quantized diffusion model to process input data based on the corrected timestep sequence and the error mean sequence to generate an output result.

12. The system as claimed in claim 11, wherein the computer program causes the processing unit to measure the quantization error by performing operations comprising:
inputting a corrected timestep and a floating-point latent variable that correspond to a current timestep in the sampling timestep sequence into the floating-point noise prediction network to obtain a predicted floating-point noise level;
computing the floating-point latent variable that corresponds to a subsequent timestep following the current timestep, based on the predicted floating-point noise level and the floating-point latent variable that corresponds to the current timestep;
inputting the corrected timestep and a quantized latent variable that correspond to the current timestep into the quantized noise prediction network to obtain a predicted quantized noise level;
computing the quantized latent variable that corresponds to the subsequent timestep following the current timestep, based on the predicted quantized noise level and the quantized latent variable that corresponds to the current timestep; and
determining the quantization error associated with the subsequent timestep by computing a deviation between the floating-point latent variable and the quantized latent variable that correspond to the subsequent timestep.

13. The system as claimed in claim 12, wherein the computer program further causes the processing unit to compute the corrected timestep sequence and the error mean sequence by:
computing an error mean and an error variance of the quantization error associated with the subsequent timestep through statistical estimation under an assumption that the quantization error follows a Gaussian distribution; and
determining the corrected timestep that corresponds to the subsequent timestep based on a signal retention hyperparameter and the error variance that are associated with the subsequent timestep.

14. The system as claimed in claim 13, wherein the computer program further causes the processing unit to:
determine whether the corrected timestep that corresponds to the subsequent timestep is greater than the subsequent timestep;
in response to determining that the corrected timestep is greater than the subsequent timestep, adjust the quantized latent variable corresponding to the subsequent timestep based on the error mean associated with the subsequent timestep, the signal retention hyperparameter associated with the subsequent timestep, and the signal retention hyperparameter associated with the corrected timestep, and set the floating-point latent variable corresponding to the subsequent timestep to the adjusted quantized latent variable; and
in response to determining that the corrected timestep is not greater than the subsequent timestep, set the error mean associated with the subsequent timestep to zero.

15. The system as claimed in claim 13, wherein the computer program further causes the processing unit to scale the predicted floating-point noise level and the predicted quantized noise level corresponding to the current timestep by a step size; and
wherein the step size is determined based on the signal retention hyperparameter of the corrected timestep corresponding to the current timestep.

16. The system as claimed in claim 11, wherein the computer program further causes the processing unit to:
initialize the input data as a quantized latent variable;
iteratively, for each corrected timestep corresponding to a current timestep in the corrected timestep sequence:
input the corrected timestep and the quantized latent variable into the quantized noise prediction network to obtain a predicted quantized noise level;
compute the quantized latent variable that corresponds to a subsequent timestep following the current timestep, based on the predicted quantized noise level and the quantized latent variable that corresponds to the current timestep;
adjust the quantized latent variable corresponding to the subsequent timestep based on an error mean associated with the subsequent timestep in the error mean sequence, a signal retention hyperparameter associated with the subsequent timestep, and the signal retention hyperparameter associated with the corrected timestep; and
generate the output result based on the quantized latent variable that corresponds to a final timestep after completing all iterations.

17. The system as claimed in claim 11, wherein the computer program further causes the processing unit to use the quantized diffusion model to process a noisy image based on the corrected timestep sequence and the error mean sequence to generate a denoised image.

18. The system as claimed in claim 11, wherein the computer program further causes the processing unit to use the quantized diffusion model to process an audio waveform with noise based on the corrected timestep sequence and the error mean sequence to generate a denoised audio waveform.

19. The system as claimed in claim 11, wherein the computer program further causes the processing unit to use the quantized diffusion model to process a random noise input based on the corrected timestep sequence and the error mean sequence to generate a synthesized image or a synthesized audio waveform.

20. The system as claimed in claim 11, wherein the computer program further causes the processing unit to use the quantized diffusion model to process a natural language prompt based on the corrected timestep sequence and the error mean sequence to generate a text sequence.
